(19) United States
(12) Patent Application Publication
(10) Pub. No.: US 2018/0128903 A1
(43) Pub. Date: May 10, 2018

(54) OPTICAL DEVICE

(71) Applicants: LITE-ON ELECTRONICS (GUANGZHOU) LIMITED, GUANGZHOU (CN); LITE-ON TECHNOLOGY CORPORATION, Taipei (TW)

(72) Inventor: Jung-Chiao Chang, Taipei (TW)

(21) Appl. No.: 15/642,370

(22) Filed: Jul. 6, 2017

Related U.S. Application Data
(60) Provisional application No. 62/419,984, filed on Nov. 10, 2016.

(51) Int. Cl. G01S 7/481; G01S 17/10

(52) U.S. Cl. CPC G01S 7/4813; G01S 7/4815; G01S 7/4816; G01S 7/4817; G01S 17/102

(57) ABSTRACT

An optical device includes a transmitting module and a receiving module. The transmitting module includes a first shell, a light source module and a first lens group. The light source module and the first lens group are arranged in the first shell. The light source module generates a collimated light through the first lens group. The receiving module includes a second shell, a light sensing module and a second lens group. The light sensing module and the second lens group are arranged in the second shell adjacent to the first shell. The light sensing module receives a reflected collimated light through the second lens group. The light source module includes at least one light-emitting diode. The first and second lens groups both include at least one lens unit. The light source module and the light sensing module respectively are arranged at one end of the first and second shells.

This application claims the benefits of U.S. provisional application Ser. No. 62/419,984, filed Nov. 10, 2016, the subject matter of which is incorporated herein by reference.

### BACKGROUND OF THE INVENTION

### Field of the Invention

The invention relates in general to an optical device, and more particularly to an optical device used in a light detection and ranging (LiDAR) module.

### Description of the Related Art

Among the electronic sensors used for detecting the ambient environment, an optical electronic sensing device using laser diode as a transmitting lighting source is a commonly seen electronic sensing device. However, due to the large volume and high cost of the electronic sensing device and the restriction of the laser output power specified in the laser safety regulations, the application of the optical electronic sensing device, such as the related application of the light detection and ranging (LiDAR) module, is restricted.

### SUMMARY OF THE INVENTION

The invention is directed to an optical device for increasing the application and popularity of optical sensing.

According to one embodiment of the present invention, an optical device including a transmitting module and a receiving module is provided. The transmitting module includes a first shell, a light source module and a first lens group. The light source module and the first lens group are arranged in the first shell. The light source module generates a collimated light through the first lens group. The receiving module includes a second shell, a light sensing module and a second lens group. The light sensing module and the second lens group are arranged in the second shell. The light sensing module receives a reflected collimated light through the second lens group. The first shell is adjacent to the second shell. The light source module includes at least a light-emitting diode (LED). The first lens group and the second lens group both include at least a lens unit. The light source module and the light sensing module respectively are arranged at one end of the first shell and one end of the second shell.

According to another embodiment of the present invention, an optical device including a transmitting module, a receiving module, an optical path calculation module and a scanning module is provided. The transmitting module includes a first shell, a light source module and a first lens group. The light source module and the first lens group are arranged in the first shell. The light source module generates a collimated light through the first lens group. The receiving module includes a second shell, a light sensing module and a second lens group. The light sensing module and the second lens group are arranged in the second shell. The light sensing module receives a reflected collimated light through the second lens group. The optical path calculation module is electrically coupled to the transmitting module and the receiving module and obtains a relative distance with respect to the collimated light according to the collimated light generated by the transmitting module and the reflected collimated light received by the receiving module. The scanning module includes a turntable and a scanning unit. The transmitting module, the receiving module and the optical path calculation module are arranged on the turntable. The collimated light generates a 3D collimated beam through the turntable and the scanning unit. The first shell is adjacent to the second shell. The light source module includes at least a light-emitting diode (LED). The first lens group and the second lens group both include at least a lens unit. The light source module and the light sensing module respectively are arranged at one end of the first shell and one end of the second shell.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1A and 1B respectively are an external view and a cross-sectional view of an optical device according to an embodiment of the invention.

FIGS. 2A and 2B respectively are an external view and a cross-sectional view of an optical device according to another embodiment of the invention.

FIG. 3 is a block diagram of an optical device used in an embodiment of the invention.

FIG. 4 is a block diagram of an optical device used in another embodiment of the invention.

FIG. 5 is a schematic diagram of an optical device according to an embodiment of the invention.

FIG. 6 is a schematic diagram of an optical device according to another embodiment of the invention.

FIG. 7 is a schematic diagram of an optical device according to an alternate embodiment of the invention.

FIG. 8 is a schematic diagram of an optical device according to an embodiment of the invention.

FIG. 9 is a schematic diagram of an optical device according to another embodiment of the invention.

FIG. 10 is a schematic diagram of a wearable device equipped with an optical device of the invention.

FIG. 11 is a schematic diagram of a transportation vehicle equipped with an optical device of the invention.

### DETAILED DESCRIPTION OF THE INVENTION

Detailed descriptions of the invention are disclosed below with a number of embodiments. However, the disclosed embodiments are for explanatory and exemplary purposes only, not for limiting the scope of protection of the invention.

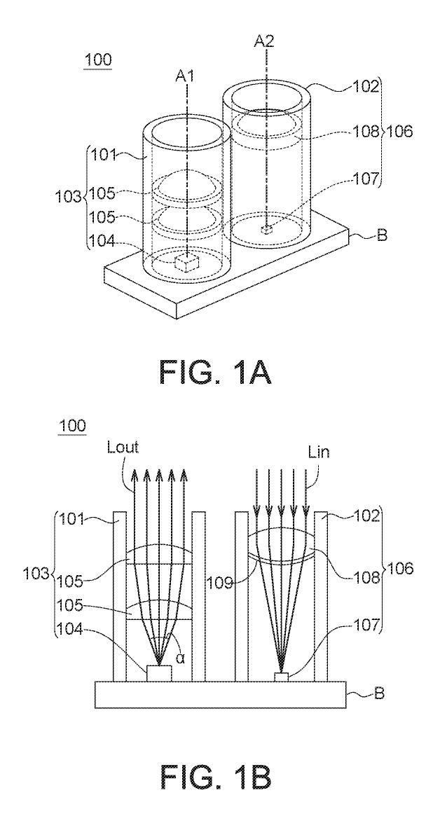

Refer to FIGS. 1A and 1B. The optical device 100 according to an embodiment of the invention includes a transmitting module 103 and a receiving module 106. The transmitting module 103 includes a first shell 101, a light source module 104 and a first lens group 105. The light source module 104 and the first lens group 105 are arranged in the first shell 101. The light source module 104 includes a light-emitting diode (LED). The first lens group 105 includes at least one lens unit.

Besides, the receiving module 106 includes a second shell 102, a light sensing module 107 and a second lens group 108. The light sensing module 107 and the second lens group 108 are arranged in the second shell 102. The first shell 101 is adjacent and parallel to the second shell 102. The center axis of the first shell 101 is parallel to the optical axis A1 of the light source module 104. The center axis of the second shell 102 is parallel to the optical axis A2 of the light sensing module 107. The light source module 104 and the light sensing module 107 respectively are arranged at one end of the first shell 101 and one end of the second shell 102. Moreover, both the first shell 101 and the second shell 102 of the present embodiment are a cylinder which facilitates the installation of the transmitting module 103 and the receiving module 106, and the two cylinders can be fixed on a bottom plate B. However, the above exemplifications are not for limiting the scope of the invention.

In an embodiment, the light source module 104 can use a LED chip, such as an infra-red LED chip or a visible light LED chip, as the light emitting source. In comparison to LED, when the laser diode is used as the light emitting source, the output power of the laser pulse wave must comply with the eye safety regulations. That is, the output power of the laser pulse wave must not cause harm to human eyes. The light source module of the present embodiment uses the LED as the light source, and therefore avoids the collimated laser light having high density of light energy radiating on the eyes. Furthermore, in comparison to the point light source such as the laser light source, the LED, being a light source with larger divergence angles than that of the laser light source, is operated to form parallel beams through a suitable lens group, provides higher safety and incurs lower cost, and therefore reduces the manufacturing cost of the optical device 100.

Refer to FIG. 1B. The light source module 104 generates a collimated light Lout through the first lens group 105, wherein the duty cycle of the collimated light Lout can be correspondingly adjusted to meet actual needs. The LED has a divergence angle α with respect to the optical axis A1 of the light source module 104. In the present embodiment, the divergence angle α of the LED can be converged through the use of at least one lens unit (such as a condenser lens) of the first lens group 105, such that the collimated beam of the light source module 104 can be similar to a laser beam. However, the quantity of lens unit is not for limiting the scope of protection of the invention.

In an embodiment, the diameter of the first lens group 105 ranges from 4 mm to 50 mm, and the numerical aperture (NA) ranges from 0.4 to 0.85. The first lens group 105, which can be formed of non-spherical lenses or spherical lenses, converges the divergence angle α of the LED to a predetermined range. As indicated in FIG. 1B, when two co-axial lens units are used, the divergence angle of the collimated light Lout passing through the first lens group 105 converges to +/−4.0°, such that the collimated light Lout generated by the light source module 104 can be transformed to a collimated beam similar to a laser beam.

In an embodiment, the first lens group 105 is arranged on the optical axis A1 of the light source module 104, and at least one LED forms the collimated light Lout through at least one lens unit of the first lens group 105; the second lens group 108 is arranged on the optical axis A2 of the light sensing module 107, and the reflected collimated light Lin is focused on the light sensing module 107 through at least one lens unit of the second lens group 108.

The second lens group 108 (such as the collimator lens) increases the signal intensity of the incident light, and has a diameter ranging from 4 mm to 50 mm. The ratio of the diameter of the second lens group 108 to the distance between the second lens group 108 and the light sensing module 107 (the focal distance) ranges from 1 to ¼, such that the second lens group 108 can be adapted to a miniaturized optical device 100. Moreover, at least one lens unit of the second lens group 108 can be coated with an optical coating 109 to shield a noise light source, such that the light whose wavelength is within a specific range (such as the infra-red light) can enter the receiving module 106, and the noise light having other wavelengths can be absorbed or reflected by the optical coating 109 to increase the signal-to-noise ratio. In another embodiment, a filter module (not illustrated), such as a filter lens, can be interposed between the second lens group 108 and the light sensing module 107 and located on the optical axis A2 of the light sensing module 107 to shield a noise light source. However, a person having ordinary skill in the art can properly combine the optical coating 109 and the filter module according to the types of the LED light sources to increase the reception efficiency of the light sensing module 107, and the present embodiment does not have specific restriction thereto.

In comparison to the conventional optical device, which uses the laser diode as the light source, the transmitting module 103 of the present embodiment, which uses LED as the light source, has a smaller volume and can be used in the miniaturized optical device 100. Meanwhile, the optical device 100 of the present embodiment having the advantage of light weight can be used in many types of wearable electronic devices, portable electronic devices or miniaturized electronic devices. The optical device of the invention can be used in a vehicle navigation/safety protection/emergency braking system, a virtual reality/amplification reality (VR/AR) detection system, an unmanned aerial vehicle detection system, a terrain/topography measurement system or a building measurement system, which is not limiting the scope of the present embodiment.

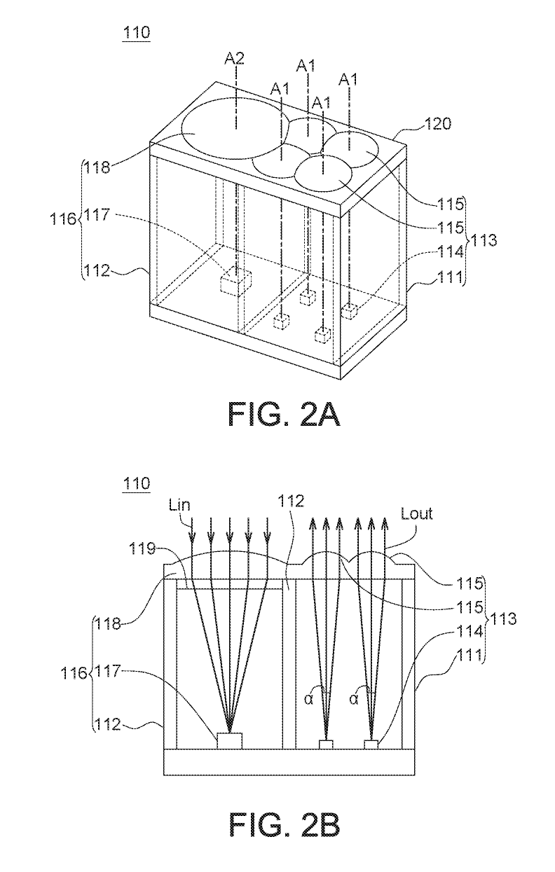

Refer to FIGS. 2A and 2B. The optical device 110 according to another embodiment of the invention includes a transmitting module 113 and a receiving module 116. The optical device 110 is similar to the optical device 100 of FIGS. 1A and 1B in that the transmitting module 113 includes a first shell 111, a light source module 114 and a first lens group 115, but is different from the optical device 100 of FIGS. 1A and 1B. The difference is that the light source module 114 includes four LEDs, and each LED is adjacent to other two LEDs to form a rectangular light source array. Besides, the first lens group 115 includes at least four lens units respectively arranged on each optical axis A1 of the four LEDs, such that the four LEDs can form a concentrated light source through four lens units to output a collimated light Lout. In other embodiments, the quantity of LEDs of the light source module 114 can be correspondingly adjusted to meet actual needs. For example, the light source module 114 can have 6 or 9 LEDs; the quantity of lens units of the first lens group 115 corresponds to the quantity of LEDs of the light source module 114 for adjustment, such that the first lens group 115 can be located on the optical axis A1 of the light source module 114 to output the collimated light Lout. The optical axis A1 of the light source module 114 is basically parallel to the optical axis A2 of the light sensing module 117.

The light source module 114 of the present embodiment uses independent LED chips, such as the infra-red LED chips or the visible light LED chips, as the light source. The light source used in the light source module 114 of the present embodiment complies with related regulations of eye safety protection. In comparison to the light source module 104, which uses single LED chip as the light source, the light source module 114 of the present embodiment uses four independent LED chips. Although the output power of the light source module 114 of the present embodiment may be equivalent to that of the light source module 104, the central intensity of the collimated light of the light source module 114 is enhanced and the ranging distance is increased.

In an embodiment, the at least four lens units of the first lens group 115, which can be formed of non-spherical lenses or spherical lenses, converges the divergence angle α of the LED to a predetermined range. In an embodiment as indicated in FIG. 2B, the divergence angle of the collimated light Lout passing through the first lens group 115 converges to +/−1.8°, such that the collimated light Lout generated by the at least four LEDs of the light source module 114 can be transformed to a collimated beam similar to a laser beam.

Moreover, the receiving module 116 is similar to the receiving module 106 of FIGS. 1A and 1B in that the receiving module 116 includes a second shell 112, a light sensing module 117 and a second lens group 118. The light sensing module 117 and the second lens group 118 are arranged in the second shell 112. The light source module 114 and the light sensing module 117 respectively are arranged at one end of the first shell 111 and one end of the second shell 112. The second lens group 118 is arranged on the optical axis A2 of the light sensing module 117. The reflected collimated light Lin passes through at least one lens unit of the second lens group 118 to be focused on the light sensing module 117.

Both the first shell 101 and the second shell 102 of the present embodiment are shaped as a long column. By using the injection molding technology, the at least one lens unit of the second lens group 118 and the at least four lens units of the first lens group 115 can be integrated as a lens array substrate 120 to be arranged at the other end of the first shell 111 and the other end of the second shell 112. Accordingly, the disposition relationship between the first shell 111 and the second shell 112 can be fixed.

The second lens group 118 is similar to the second lens group 108 of FIGS. 1A and 1B. Through the disposition of an optical coating 119 and a filter module (not illustrated), the reception efficiency of the light sensing module 107 is increased. The optical coating 119 is similar to the optical coating 109 of FIG. 1B, and the present embodiment does not have specific restrictions regarding such arrangement.

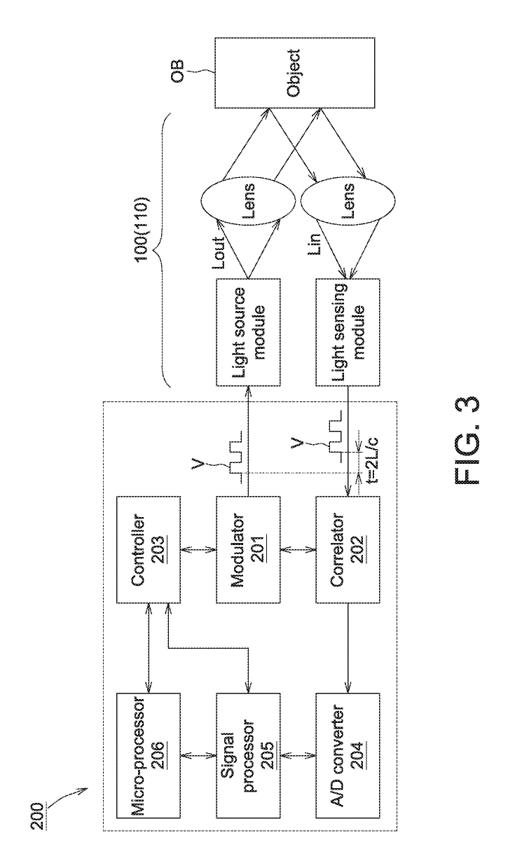

Refer to FIG. 3. The optical path calculation module 200 according to an embodiment of the invention is electrically coupled to the optical device 100 or 110, and calculates the distances between the optical device 100 (or the optical device 110) and the object OB. The optical path calculation module 200 includes a modulator 201, a correlator 202 and a plurality of signal processing/controlling units (203˜206). The modulator 201 outputs a pulse voltage V having a specific frequency to the light source module, and the controller 203 controls the duty cycle of the collimated light Lout by modulating the pulse width of the pulse voltage V. Besides, the correlator 202 demodulates the collimated light Lin reflected from the object OB, and finds out the characteristics (such as phase angle) of an unknown pulse signal according to a function of a known pulse signal with respect to time, so as to obtain the correlation (such as the phase difference) between two pulse signals. In the present embodiment, the optical path calculation module 200 calculates the flight time of the collimated light by using the correlator 202, converts the flight time into a digital signal by using an A/D converter 204, and calculates the flight distance of the collimated light by using the micro-processor 206 and the signal processor 205. Let the flight time be denoted by t, the light speed be denoted by c, the flight distance of the collimated light (about two times of the distance from the light source module to the object OB) be denoted by 2 L. Then, the flight time t can be expressed as: t=2 L/c. Therefore, the optical path calculation module 200 of the present embodiment, by using the phase modulation technology, can calculate a total flight distance travelled by a specific collimated light, which is emitted by the optical device, reflected from a surface of the object, and received by the optical device, so as to obtain the relative distance with respect to the object OB according to the collimated light.

The controller 203, the micro-processor 206, the signal processor 205 and the A/D converter 204 can be integrated as a single IC chip, or can be independent signal processing and control chip sets, and the embodiment does not have specific restriction thereto. Thus, the optical path calculation module 200 can be combined with the optical devices 100 or 110 of FIGS. 1A, 1B, 2A, and 2B to form a light detection and ranging (LiDAR) module.

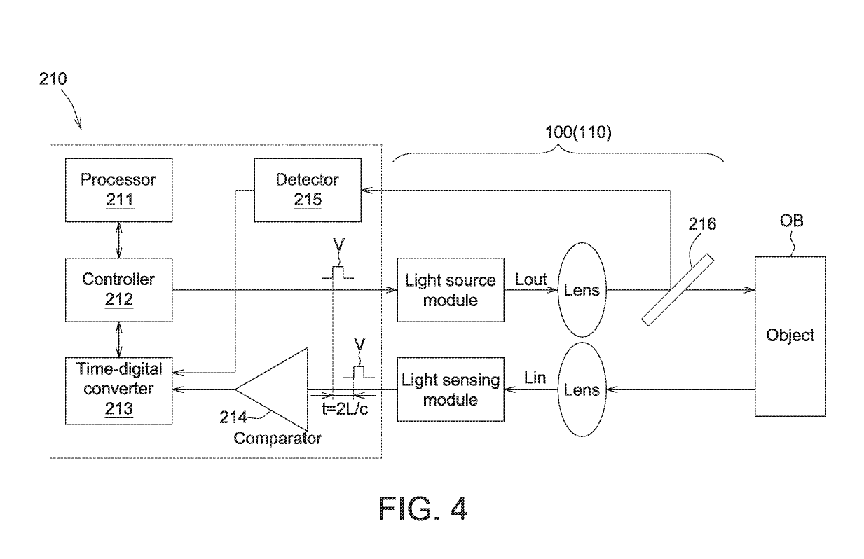

Refer to FIG. 4. The optical path calculation module 210 according to another embodiment of the invention is electrically coupled to the optical device 100 or 110, and correspondingly calculates the distance between the optical device 100 or 110 and the object OB. The optical path calculation module 210 includes a processor 211, a controller 212, a time-digital converter 213, a comparator 214, a detector 215 and a beam splitter 216. The controller 212 outputs a pulse voltage V having a specific frequency to the light source module. The beam splitter 216 splits the outputted collimated light Lout into two beams, such that a part of the beams is sampled by the detector 215 and used as a reference pulse signal outputted to the time-digital converter 213. Besides, the time-digital converter 213 receives the reference pulse signal and another delay pulse signal outputted from the comparator 214 to calculate the time difference. In the present embodiment, the optical path calculation module 210 calculates the flight time of the collimated light by using the time-digital converter 213, and calculates the flight distance of the collimated light by using the processor 211. Let the flight time be denoted by t, the light speed be denoted by c, and the flight distance of the collimated light (about two times of the distance from the light source module to the object OB) be denoted by 2 L. Then, the flight time t can be expressed as: t=2 L/c. Therefore, by using the time-digital conversion technology, the optical path calculation module 210 of the present embodiment can calculate a total flight distance travelled by a specific collimated light, which is emitted by the optical device, reflected from a surface of the object, and received by the optical device, so as to obtain the relative distance with respect to the object OB according to the collimated light.

The processor 211, the controller 212, the comparator 214 and the time-digital converter 213 can be integrated as a single IC chip, or can be independent signal processing and control chip sets, and the embodiment does not have specific restriction thereto. In addition, the optical path calculation module 210 can be combined with the optical device 100 or 110 of FIGS. 1A, 1B, 2A, and 2B to form a LiDAR module.

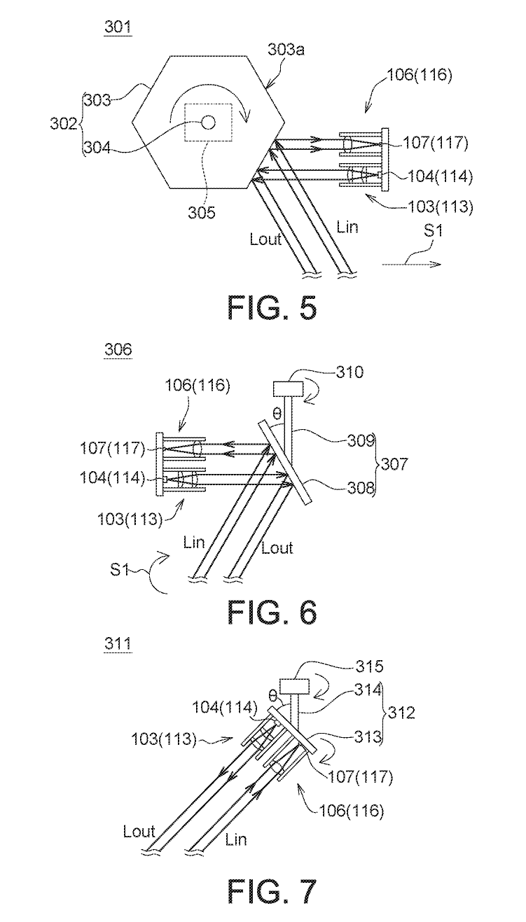

Refer to FIG. 5. The optical device 301 according to an embodiment of the invention includes the transmitting module 103 (113), the receiving module 106 (116) and a scanning module 302. In an embodiment, the scanning module 302 includes a scanning unit 303 and a turntable 304. For example, the scanning unit 303 can be a polygon scanning mirror; the shaft of the turntable 304 is driven to rotate by a driver 305 (such as a motor); the scanning unit 303 is electrically coupled to the turntable 304 and rotated around the shaft of the turntable 304. Let the hexagon scanning mirror be taken for example. The collimated light Lout emitted from the light source module 104 (114) radiates on a mirror surface 303a of the hexagon scanning mirror. After a period of flight time, the reflected collimated light Lin is reflected to the light sensing module 107 (117) from the mirror surface 303a. Then, the optical path calculation module (not illustrated) calculates the flight distance of the collimated light according to the reflected collimated light Lin. When the scanning unit 303 rotates, the collimated light form a scanning beam on a first scanning direction S1 along the change of the rotation angle of the scanning unit 303 as a basis for linear scanning.

Refer to FIG. 6. The optical device 306 according to an embodiment of the invention includes the transmitting module 103 (113), the receiving module 106 (116) and a scanning module 307. In comparison to the optical device 301 of FIG. 5, the scanning unit 308 of the optical device 306 of the present embodiment can be a plane mirror, and the shaft of the turntable 309 is driven to rotate by a driver 310 (such as a motor). Moreover, the scanning unit 308 is coupled to the turntable 309, and an angle θ is formed between a shaft of the turntable 309 and an extension line of the scanning unit 308, such that the scanning unit 308 can rotate around the shaft of the turntable 309. When the scanning unit 308 rotates, the collimated light Lout emitted from the light source module 104 (114) emits onto a mirror surface of the scanning unit 308. After a period of flight time, the reflected collimated light Lin is reflected to the light sensing module 107 (117) from the mirror surface. Then, the optical path calculation module (not illustrated) calculates the flight distance of the collimated light according to the reflected collimated light Lin. Thus, when the scanning unit 308 rotates, the collimated light can form a scanning beam in the first scanning direction S1 as a basis for linear scanning.

Refer to FIG. 7. The optical device 311 according to an embodiment of the invention includes the transmitting module 103 (113), the receiving module 106 (116) and a scanning module 312. Like the optical device 306 of FIG. 6, the turntable 313 not only rotates along the shaft 314, but also has an adaptively changing angle θ with respect to the shaft 314, so as to provide a 30 scanning operation on a 2D plane.

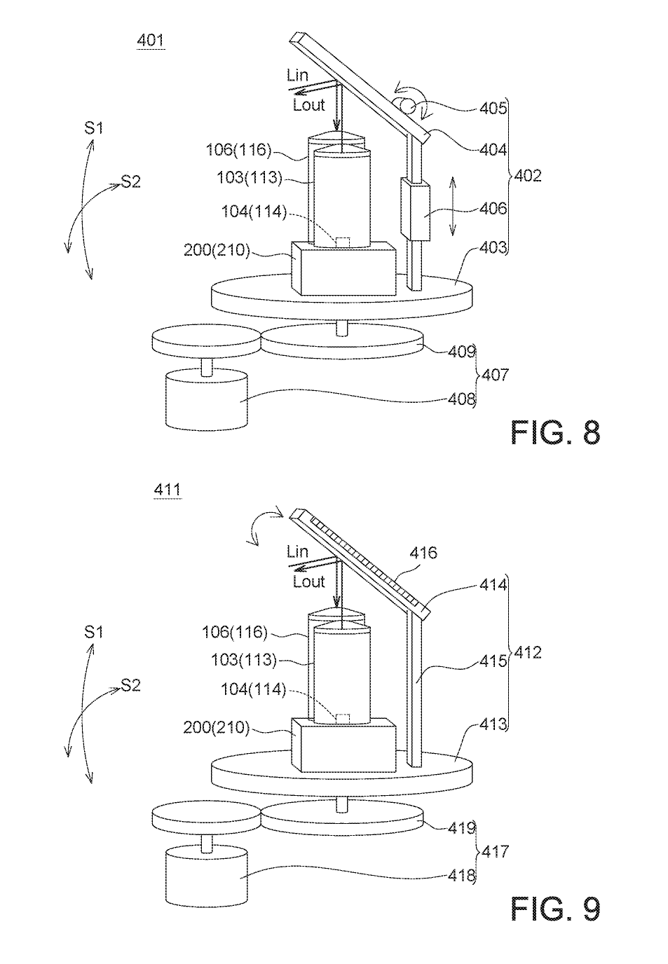

Refer to FIG. 8. The optical device 401 according to an embodiment of the invention includes the transmitting module 103 (113), the receiving module 106 (116), the optical path calculation module 200 (210) and a scanning module 402. The scanning module 402 includes a turntable 403 and a scanning unit (a reflector 404, a shaft 405 and a driver 406). The reflector 404, which can be a plane mirror, is coupled to the shaft 405. Meanwhile, the reflector 404 is driven by the driver 406 (such as a linear motor) to rotate around the shaft 405. Thus, when the reflector 404 rotates, the scanning direction of the collimated light Lout emitted from the light source module 104 (114) can be changed through a facing surface of the reflector 404, and the reflected collimated light Lin can also be reflected to the receiving module 106 (116) from the facing surface of the reflector 404, such that the collimated light can form a first scanning beam in the first scanning direction S1 (that is, the 3D scanning mode).

Refer to FIG. 8. The scanning unit (the reflector 404, the shaft 405 and the driver 406), the transmitting module 103 (113), the receiving module 106 (116) and the optical path calculation module 200 (210) are arranged on the turntable 403. The turntable 403 can be driven to rotate by another driver 407 (such as a motor-gear set formed by a motor 408 and multiple gears 409). Thus, motor 408 can drive multiple gears 419 to rotate, such that the transmitting module 103 (113) and the receiving module 106 (116) can be operated as a plane rotation operation, and the collimated light generated by the transmitting module 103 (113) can form a second scanning beam in the second scanning direction S2 (that is, the plane scanning mode). Under such circumstance, the collimated light travels along changes of the rotation angle of the reflector 404 in the first scanning direction S1 and the rotation angle of the turntable 403 in the second scanning direction S2, to form a 3D collimated beam for the 3D scanning.

Refer to FIG. 9. The optical device 411 according to an embodiment of the invention includes the transmitting module 103 (113), the receiving module 106 (116), the optical path calculation module 200 (210) and a scanning module 412. In comparison to the optical device 401 of FIG. 8, the scanning module 412 of the optical device 411 of the present embodiment includes a turntable 413 and a scanning unit (e.g. a reflective galvanometer 414 and a supporting member 415). The supporting member 415 is fixedly coupled to the reflective galvanometer 414 and a turntable 413. The reflective galvanometer 414, which can be an MEMS (micro-electro-mechanical system) scanning galvanometer, includes an X rotation axis, a Y rotation axis, a conductive coil 416 arranged on the reflective galvanometer and the magnets (not illustrated) located on the top and the bottom of the reflective galvanometer 414. When the current flows through the conductive coil 416, the conductive coil 416 in the magnetic field will be affected by the Ampere's force to generate a torque which deflects the galvanometer with respect to the X rotation axis and/or the Y rotation axis. When the reflective galvanometer 414 is deflected by the torque, the collimated light Lout emitted from the light source module 104 (114) can form a first scanning beam in the first scanning direction S1. Moreover, the scanning unit (the reflective galvanometer 414 and the supporting member 415), the transmitting module 103 (113), the receiving module 106 (116) and the optical path calculation module 200 (210) are also arranged on the turntable 413 and the collimated light forms a second scanning beam in the second scanning direction S2 when the turntable 413 rotates. Accordingly, the first scanning beam in the first scanning direction S1 and the second scanning beam in the second scanning direction S2 are combined to generate a 3D collimated beam.

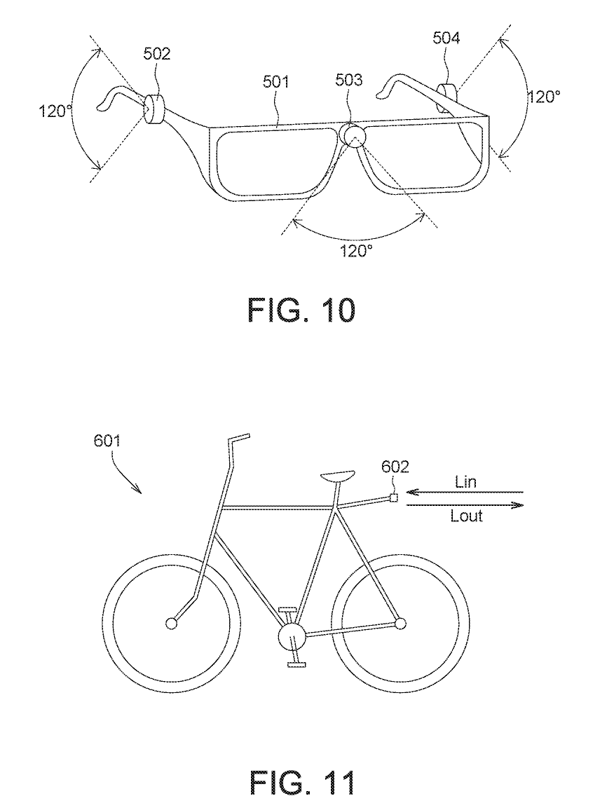

Refer to FIG. 10. In the VR and AR applications, any of the miniaturized optical devices 502-504 disclosed in above embodiments can be disposed on the wearable device 501 (such as the smart glasses) to detect the interactive environment and perform positioning. The optical devices 502-504 can be realized by any one of the optical devices 100, 110, 301, 306, 311, 401, and 411. The miniaturized optical devices 502-504 can be arranged at the front, the left and the right of the wearable device 501 to form a triangular geometric space to detect the 3D image in the ambient environment. The view angle of each 3D image is about 120°. The 3D images in three different directions can be combined as a panoramic image. Then, the panoramic image is further transmitted to an image processor through a wireless network to construct a virtual image, capable of interacting with the real world. Thus, the wearable device 501 can construct an interactive environment without using any panoramic camera disposed in the ambient environment. Moreover, when many users are in the interactive space at the same time, the users can perform positioning using their own wearable device 501, such that the problem of the camera angle being shielded can be avoided, and the scope of VR and AR applications of the wearable device 501 can be expanded.

The miniaturized optical devices 502-504 can also be used in an unmanned aerial vehicle to perform detection through aerial photography or play virtual games. The miniaturized optical devices 502-504 have a tracking shot function capable of detecting the 3D image in the ambient environment along the user's movement to construct a lifelike virtual image.

Refer to FIG. 11. In the application of vehicle safety protection, the miniaturized optical device 602 disclosed in any of above embodiments can be disposed on a transportation vehicle 601 (such as a bike or a motor bike) to detect the change in the ambient environment. The optical device 602, which can be realized by any one of the optical devices 100 and 110, 301, 306, 311, 401, and 411, is arranged at the rear of the transportation vehicle 601. When any vehicle from behind approaches the optical device 602, the optical device 602 can detect whether the coming vehicle is within a safe range according to the collimated light Lout and the collimated light Lin which are emitted from the optical device and received by the optical device 602 respectively. The optical device 602 can warn the driver of possible collision by triggering a warning message, such as a series of beeps.

In comparison to the conventional optical device, which uses the laser diode as a light source and may cause harm to human eyes, the optical device of the above embodiments of the invention uses the LED chip as a light source to achieve low output power and high safety. Meanwhile, the optical device of the above embodiments of the invention, advantageously having smaller volume and lighter weight, can be adaptively used in many types of wearable electronic devices, transportation vehicles, unmanned aerial vehicles or other miniaturized electronic devices. Moreover, when the optical device of the above embodiments of the invention is combined with different scanning modules and light sources, the collimated light of the optical device can be used to scan in different dimensions and meet the requirements for the ranging of short, medium and long distances.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical device, comprising:
a transmitting module, comprising a first shell, a light source module and a first lens group, wherein the light source module and the first lens group are arranged in the first shell, and the light source module generates a collimated light through the first lens group; and
a receiving module, comprising a second shell, a light sensing module and a second lens group, wherein the light sensing module and the second lens group are arranged in the second shell, and the light sensing module receives a reflected collimated light through the second lens group;
wherein, the first shell is adjacent to the second shell, the light source module comprises at least one light-emitting diode, the first lens group and the second lens group both comprise at least one lens unit, and the light source module and the light sensing module respectively are arranged at one end of the first shell and one end of the second shell.

2. The optical device according to claim 1, wherein the first lens group is arranged on an optical axis of the light source module, the at least one light-emitting diode forms the collimated light through at least one lens unit of the first lens group, the second lens group is arranged on an optical axis of the light sensing module, and the reflected collimated light is focused on the light sensing module through at least one lens unit of the second lens group.

3. The optical device according to claim 1, wherein the light source module comprises four light-emitting diodes, and each of the light-emitting diodes is adjacent to other two of the light-emitting diodes to form a rectangular light source array.

4. The optical device according to claim 3, wherein the first lens group comprises at least four lens units respectively arranged on the optical axis of the four light-emitting diodes, such that the four light-emitting diodes form the collimated light through the four lens units.

5. The optical device according to claim 3, wherein at least four lens units of the first lens group and at least one lens unit of the second lens group form a lens array substrate and are arranged at the other end of the first shell and the other end of the second shell.

6. The optical device according to claim 1, further comprising an optical path calculation module, wherein the optical path calculation module obtains a relative distance with respect to the collimated light according to the collimated light generated by the transmitting module and the reflected collimated light received by the receiving module.

7. The optical device according to claim 6, wherein the optical path calculation module obtains the relative distance by using a phase modulation technology or a time-digital conversion technology.

8. The optical device according to claim 1, wherein the receiving module further comprises at least one filter module arranged between the light sensing module and the second lens group and located on the optical axis of the light sensing module to shield a noise light source.

9. The optical device according to claim 1, wherein at least one lens unit of the second lens group is further coated with an optical coating to shield a noise light source.

10. The optical device according to claim 1, further comprising a scanning module, wherein the scanning module comprises a turntable and a scanning unit, the transmitting module and the receiving module are arranged on the turntable to generate a 3D collimated beam by using the scanning unit.

11. The optical device according to claim 10, wherein the turntable comprises a plurality of gears and a motor, and further performs a plane rotation operation for the transmitting module and the receiving module when the gears are rotated by the motor.

12. The optical device according to claim 10, wherein the scanning unit comprises a linear motor and a reflector, such that the collimated light generated by the transmitting module is transformed to the 3D collimated beam.

13. The optical device according to claim 10, wherein the scanning unit comprises an MEMS (micro-electro-mechanical system) scanning galvanometer, such that the collimated light generated by the transmitting module is transformed to the 3D collimated beam.

14. The optical device according to claim 1, arranged on a wearable device, a transportation vehicle or an unmanned aerial vehicle.

15. An optical device, comprising:
a transmitting module, comprising a first shell, a light source module and a first lens group, wherein the light source module and the first lens group are arranged in the first shell, and the light source module generates a collimated light through the first lens group;
a receiving module, comprising a second shell, a light sensing module and a second lens group, wherein the light sensing module and the second lens group are arranged in the second shell, and the light module receives a reflected collimated light through the second lens group;
an optical path calculation module, coupled to the transmitting module and the receiving module, wherein the optical path calculation module obtains a relative distance with respect to the collimated light according to the collimated light generated by the transmitting module and the reflected collimated light received by the receiving module; and
a scanning module, comprising a turntable and a scanning unit, wherein the transmitting module, the receiving module and the optical path calculation module are arranged on the turntable, and the collimated light generates a 3D collimated beam through the turntable and the scanning unit;
wherein, the first shell is adjacent to the second shell, the light source module comprises at least one light-emitting diode, the first lens group and the second lens group both comprise at least one lens unit, and the light source module and the light sensing module respectively are arranged at one end of the first shell and one end of the second shell.
